(19) United States
(12) Patent Application Publication
(10) Pub. No.: US 2007/0019844 A1
(43) Pub. Date: Jan. 25, 2007

(54) Authentication device, authentication method, authentication program, and computer readable recording medium

(75) Inventors: Manabu Yumoto, Nara-shi (JP); Manabu Onozaki, Nara-shi (JP); Masayuki Ehiro, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/491,062

(22) Filed: Jul. 24, 2006

(30) Foreign Application Priority Data
Jul. 25, 2005 (JP) 2005-214498 (P)

(51) Int. Cl. G06K 9/00

(52) U.S. Cl. 382/124

(57) ABSTRACT

An authentication device collates a first input image input to a sensor using a first method with a reference image, collates a second input image input to a sensor using a second method with the reference image, and outputs a result of authentication based on results of collations using the first and the second methods.

This nonprovisional application is based on Japanese Patent Application No. 2005-214498 filed with the Japan Patent Office on Jul. 25, 2005, the entire contents of which are hereby incorporated by reference.

### FIELD OF THE INVENTION

The present invention relates to an authentication device, and more specifically to an authentication device, an authentication method, an authentication program, and a computer-readable recording medium in which input image information obtained by using both of a sweep sensing method and an area sensing method can be used in combination.

### DESCRIPTION OF THE BACKGROUND ART

In mobile equipment represented by a portable phone, commercial transactions utilizing the mobile equipment, such as access to financial institutions over a network or the like or purchase of a product at a vending machine through radio wave, have become possible. A fingerprint authentication function has been put into practical use as a method of authenticating an individual or the like in commercial transactions.

Conventionally, an area sensing method or a sweep sensing method has been used as a method of inputting a fingerprint image in the fingerprint authentication function provided to the mobile equipment or the like. FIG. 13 illustrates the area sensing method, while FIG. 14 illustrates the sweep sensing method.

Referring to FIG. 13, in the area sensing method, fingerprint information sensed at one time on a full area is input to a device or the like for collation (see Japanese Patent Laying-Open No. 2003-323618).

Meanwhile, referring to FIG. 14, in the sweep sensing method, the fingerprint is sensed while a finger is moved over a sensor (for example, in a direction shown with an arrow in the drawing) (see Japanese Patent Laying-Open No. 05-174133).

Conventionally, when a person is authenticated using his/her fingerprint, it is possible to use either the area sensing method or the sweep sensing method described above.

With the growing tendency toward cashless transactions and development of network technology in recent years, improvement in authentication accuracy in the fingerprint authentication function as above has strongly been desired.

### SUMMARY OF THE INVENTION

The present invention was made in view of the above-described problems, and an object of the present invention is to improve an authentication function in an authentication device.

An authentication device according to the present invention includes: an image input unit including a sensor and allowing input of an image of an object using either a first method in which relative position between the sensor and the object is fixed or a second method in which relative position between the sensor and the object is varied; a reference image holding unit holding a reference image to be collated with an input image input through the image input unit; a first collating unit collating a first input image input through the image input unit using the first method with the reference image; a second collating unit collating a second input image input through the image input unit using the second method with the reference image; and an authentication unit outputting a result of authentication based on a result of collation by the first collating unit and a result of collation by the second collating unit.

An authentication method according to the present invention includes the steps of: collating a first input image with a reference image, the first input image being input with relative position between a sensor and an object being fixed; collating a second input image with the reference image, the second input image being input with relative position between a sensor and an object being varied; and outputting a result of authentication based on a result of collation of the first input image and a result of collation of the second input image.

An authentication program according to the present invention is a program for authentication based on an image input to a sensor, and causes a computer to execute the steps of: collating a first input image with a reference image, the first input image being input with relative position between the sensor and an object being fixed; collating a second input image with the reference image, the second input image being input with relative position between the sensor and an object being varied; and outputting a result of authentication based on a result of collation of the first input image and a result of collation of the second input image.

A computer-readable recording medium according to the present invention records the authentication program described above.

According to the present invention, respective images input by using two different methods are collated with the reference image, and the results of collation are used to output a result of authentication. Accuracy in collation of the input images can thus be improved, and therefore, authentication accuracy can be improved.

In addition, as input of images using a plurality of methods is required, input of an image obtained with a fraudulent method is less likely. Accordingly, fraudulent image input such as input of a fingerprint of others can more reliably be avoided. Improvement in authentication accuracy in the authentication device can minimize the risk particularly in transactions involving high value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a computer on which an authentication device in accordance with a first embodiment of the present invention is mounted.

FIG. 2 is a block diagram representing a functional configuration of the authentication device mounted on the computer in FIG. 1.

FIGS. 3A and 3B illustrate a manner of sensing a fingerprint in the authentication device in FIG. 2.

FIG. 4 is a flowchart of an image collation process performed in the authentication device in FIG. 2.

FIG. 5 is a flowchart of a subroutine of a process for determining whether input has been made or not in FIG. 4.

FIG. 6 is a flowchart of a subroutine of a snap shot image reference position correction process in FIG. 4.

FIGS. 7A to 7D illustrate the contents of the snap shot image reference position correction process in FIG. 6.

FIG. 8 is a flowchart of a subroutine of a process for determining a fingerprint input and collation method in FIG. 4.

FIG. 9 is a flowchart of a subroutine of a similarity score calculation process in FIG. 4 when an area sensing method is selected in the authentication device in FIG. 1.

FIG. 10 is a flowchart of a subroutine of the similarity score calculation process in FIG. 4 when a sweep sensing method is selected in the authentication device in FIG. 1.

FIGS. 11A to 11C illustrate the contents of authentication in the authentication device in FIG. 1.

FIGS. 12A and 12B illustrate a variation of a sensor used in the authentication device in FIG. 2.

FIG. 13 illustrates fingerprint authentication in accordance with the area sensing method in conventional equipment.

FIG. 14 illustrates fingerprint authentication in accordance with the sweep sensing method in conventional equipment.

### DESCRIPTION OF THE PREFERRED EMBODIMENTS

(First Embodiment)

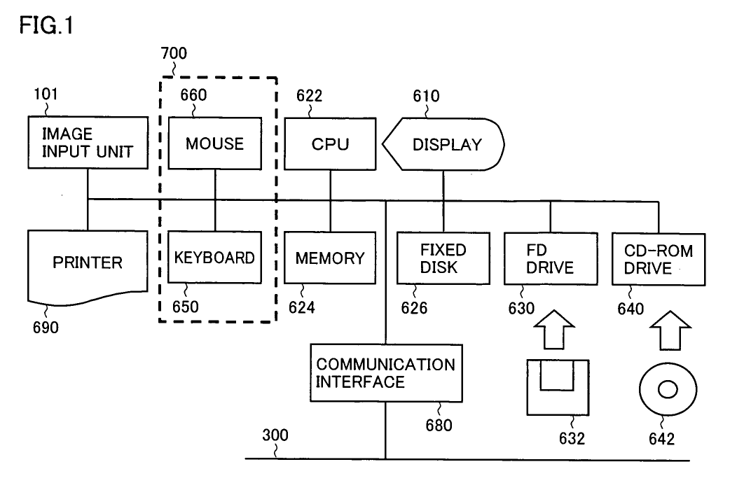

Referring to FIG. 1, a computer incorporating an authentication device 1 according to the first embodiment of the present invention includes an image input unit 101, a display 610 such as a CRT (Cathode Ray Tube) or a liquid crystal display, a CPU 622 (Central Processing Unit) for central management and control of the computer itself, a memory 624 including an ROM (Read Only Memory) or an RAM (Random Access Memory), a fixed disk 626, an FD drive 630 on which an FD (flexible disk) 632 is detachably mounted and which accesses to FD 632 mounted thereon, a CD-ROM drive 640 on which a CD-ROM (Compact Disc Read Only Memory) 642 is detachably mounted and which accesses to mounted CD-ROM 642, a communication interface 680 for connecting the computer to a communication network 300 for establishing communication, and an input unit 700 having a keyboard 650 and a mouse 660. These components are connected through a bus for communication. Further, it is connected to a printer 690 as an external apparatus.

The configuration shown in FIG. 1 is a general computer configuration, and the computer configuration of the present embodiment is not limited to that in FIG. 1. For example, the computer may be provided with a magnetic tape apparatus accessing to a cassette type magnetic tape that is detachably mounted thereto.

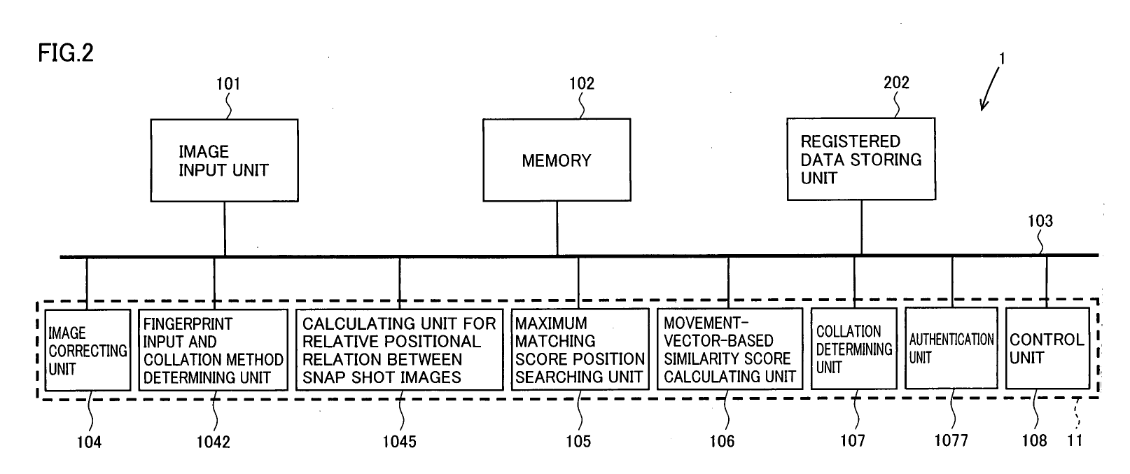

Referring to FIG. 2, an authentication device 1 includes image input unit 101, a memory 102 (that corresponds to memory 624 or fixed disk 626 in FIG. 1), a bus 103, a registered data storing unit 202, and a collation process unit 11.

Collation process unit 11 includes an image correcting unit 104, a fingerprint input and collation method determining unit 1042, a calculating unit 1045 for relative positional relation between snap shot images, a maximum matching score position searching unit 105, a movement-vector-based similarity score calculating unit (hereinafter referred to as a similarity score calculating unit) 106, a collation determining unit 107, an authentication unit 1077, and a control unit 108. Functions of these units in collation process unit 11 are realized when corresponding programs are executed.

In the present embodiment, image input unit 101 implements an image input unit; registered data storing unit 202 implements a reference image holding unit; memory 102 implements a collation method selection information holding unit; fingerprint input and collation method determining unit 1042 implements a collation method determining unit; maximum matching score position searching unit 105, similarity score calculating unit 106 and collation determining unit 107 implement a still image collating unit; and calculating unit 1045 for relative positional relation between snap shot images, maximum matching score position searching unit 105, similarity score calculating unit 106, and collation determining unit 107 implement a varying image collating unit. Authentication unit 1077 implements an authentication unit. In addition, memory 102 and control unit 108 have the function of general storage and control of the entire components.

Image input unit 101 includes a fingerprint sensor, and outputs fingerprint image data that corresponds to the fingerprint read by the fingerprint sensor. The fingerprint sensor may be an optical, a pressure-type, a static capacitance type or any other type sensor.

The fingerprint sensor included in image input unit 101 can operate in accordance with both the sweep sensing method (hereinafter simply referred to as sweep method) and the area sensing method (hereinafter simply referred to as area method) described above, and it can read fingerprint data sensed using either of these methods.

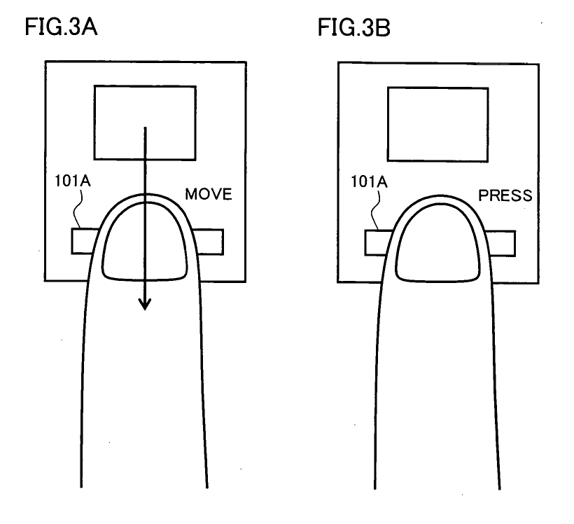

Specifically, when the fingerprint data is to be sensed by the sweep method using the fingerprint sensor included in image input unit 101, as shown in FIG. 3A, a user is requested to place his/her finger on a rectangular sensor 10A at right angles to the longitudinal direction thereof, and to move his/her finger over sensor 101A downward (or upward) perpendicular to the longitudinal direction of sensor 101A as shown with an arrow in the drawing, so that the fingerprint data is read.

When the fingerprint data is to be sensed by the area method, as shown in FIG. 3B, the user is requested to place his/her finger on rectangular sensor 101A in parallel to the longitudinal direction thereof, and the fingerprint data is read while the finger is kept stationary on sensor 10A.

The size of the fingerprint sensor included in image input unit 101 must be equal to or larger than the minimum necessary size for sensing by the area method. For example, the width, which corresponds to the length of the sensor in the longitudinal direction, must be about 1.5 times the width of the finger (256 pixels), and the length, which corresponds to the length of the sensor in the direction orthogonal to the longitudinal direction, must be about 0.25 times the width of the finger (64 pixels).

In authentication device 1, when the fingerprint data is sensed by the area method, attained accuracy of collation is not very high, as the fingerprint sensor having the length of about 0.25 times the finger width is used. The necessary time, however, is shorter than that for the sweep method, and therefore, it is suitably used for simple fingerprint identification and convenient for the user. When the fingerprint data is sensed by the sweep method, it takes longer time, while collation accuracy is higher. Therefore, it can be used for fingerprint identification required for highly confidential purposes.

Memory 102 stores image data and various calculation results. Bus 103 is used for transferring control signals and data signals between these units. Image correcting unit 104 performs density correction of the fingerprint image data input through image input unit 101.

Maximum matching score position searching unit 105 uses a plurality of partial areas of one fingerprint image as templates, and searches for a position of the other fingerprint image that attains to the highest matching score with the templates. Namely, it performs so-called template matching. The result of searching, that is, the resulting information, is passed to and stored in memory 102.

Using the information of the result from maximum matching score position searching unit 105 stored in memory 102, similarity score calculating unit 106 calculates the movement-vector-based similarity score, which will be described later. The calculated similarity score is passed to similarity score determining unit 107.

Similarity score determining unit 107 determines a match/mismatch, based on the similarity score calculated by similarity score calculating unit 106.

Authentication unit 1077 carries out authentication of an individual or the like corresponding to combination of collated images.

Control unit 108 controls processes performed by various units of collation process unit 11.

Registered data storing unit 202 stores image data used for collation in advance, separately from a set of aforementioned snap shot images to be collated.

In the present embodiment, part of or all of image correcting unit 104, fingerprint input and collation method determining unit 1042, calculating unit 1043 for relative positional relation between snap shot images, maximum matching score position searching unit 105, similarity score calculating unit 106, collation determining unit 107, authentication unit 1077, and control unit 108 may be implemented by an ROM such as memory 624 (see FIG. 1) storing the process procedure as a program and a processor including CPU 622 (see FIG. 1) and the like for executing the program.

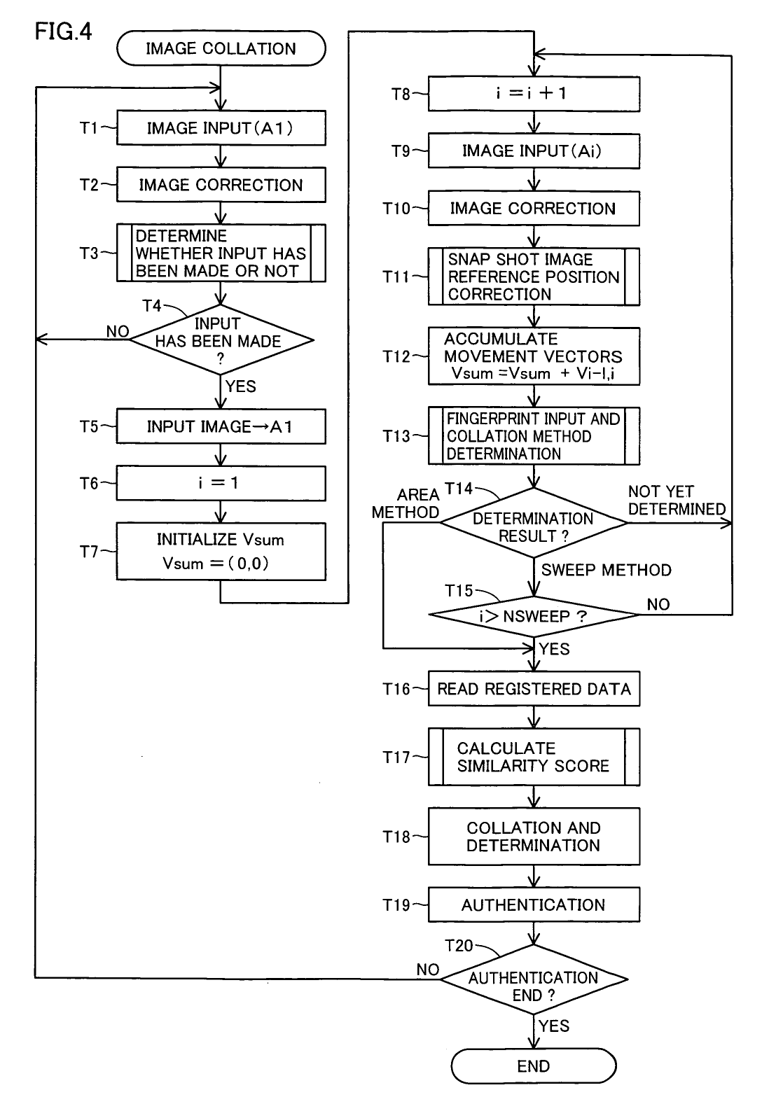

The contents of image collation process executed in authentication device 1 will be described with reference to the flowchart of FIG. 4.

Referring to FIG. 4, initially, authentication device 1 waits until the finger of a person to be authenticated is placed on the sensor (steps T1 to T4).

Specifically, first, control unit 108 transmits an image input start signal to image input unit 101, and thereafter waits until an image input end signal is received. When the finger is placed on the sensor, image input unit 101 creates an image of the fingerprint to be collated (hereinafter, the created image is referred to as image A), which image is stored at a prescribed address of memory 102 through bus 103 (step T1). After storage (input) of an image A1 is completed, image input unit 101 transmits the image input end signal to control unit 108.

Thereafter, control unit 108 transmits an image correction start signal to image correcting unit 104, and thereafter, waits until an image correction end signal is received. In most cases, image A1 has uneven image quality, as tones of pixels and overall density distribution vary because of characteristics of image input unit 101, dryness of fingerprint itself and pressure with which fingers are pressed. Therefore, it is considered as not appropriate to use the input image data directly for collation. Image correcting unit 104 corrects the image quality of input image to suppress variations of conditions when the image is input (step T2). Specifically, image correcting unit 104 subjects image A1 stored in memory 102 to histogram planarization (“Computer GAZOU SHORI NYUMON” (Introduction to computer image processing), SOKEN SHUPPAN, p. 98) or image binarization (“Computer GAZOU SHORI NYUMON” (Introduction to computer image processing), SOKEN SHUPPAN, pp. 66-69), for the overall image or small areas obtained by dividing the same.

After the end of image correcting process on image A1, image correcting unit 104 transmits the image correction process end signal to control unit 108.

In authentication device 1, the process above is repeated until a new image is input (steps T3, T4).

The process in step T3 (process for determining whether input has been made or not) will be described in detail with reference to FIG. 5 showing the flowchart of the subroutine of the process.

Referring to FIG. 5, in the process, initially, image input unit 101 calculates Bratio which represents a ratio of the number of black pixels in the image (corresponding to the ridgeline of the fingerprint image) to the total number of pixels including white pixels as the background, in the data input to the sensor (step SB001).

If the value of Bratio exceeds a certain value (MINBratio), image input unit 101 determines that the input has been made and returns “Y” to control unit 108. Otherwise, image input unit 101 determines that the input has not been made and returns “N” to control unit 108 (steps SB002 to SB004).

Referring again to FIG. 4, in control unit 108, if “Y” is returned from image input unit 101 in step T4, the process proceeds to step T5, and if “N” is returned from image input unit 101 in step T4, the process returns to step T1.

Then, control unit 108 stores the input image at a specific address in memory 102 as image A1 (step T5), and initializes variables at specific addresses on memory 102 (steps T6, T7).

Thereafter, control unit 108 increments and updates variable i on memory 102 by “1” (step T8).

Thereafter, in authentication device 1, as in steps T1, T2, an ith image Ai is input through image input unit 101 and image correction of image Ai is performed (steps T9, T10).

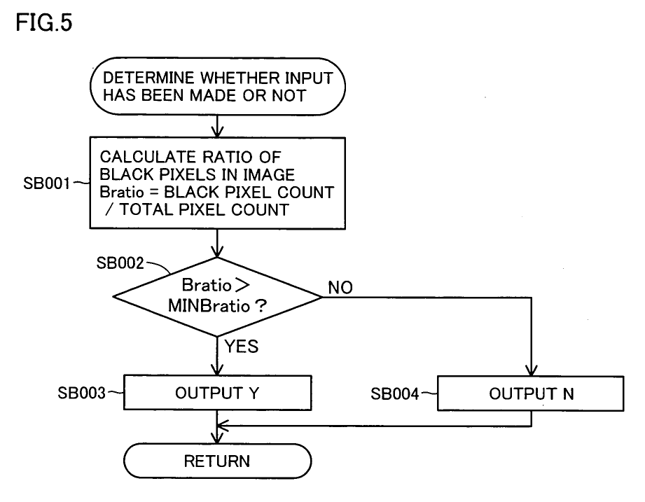

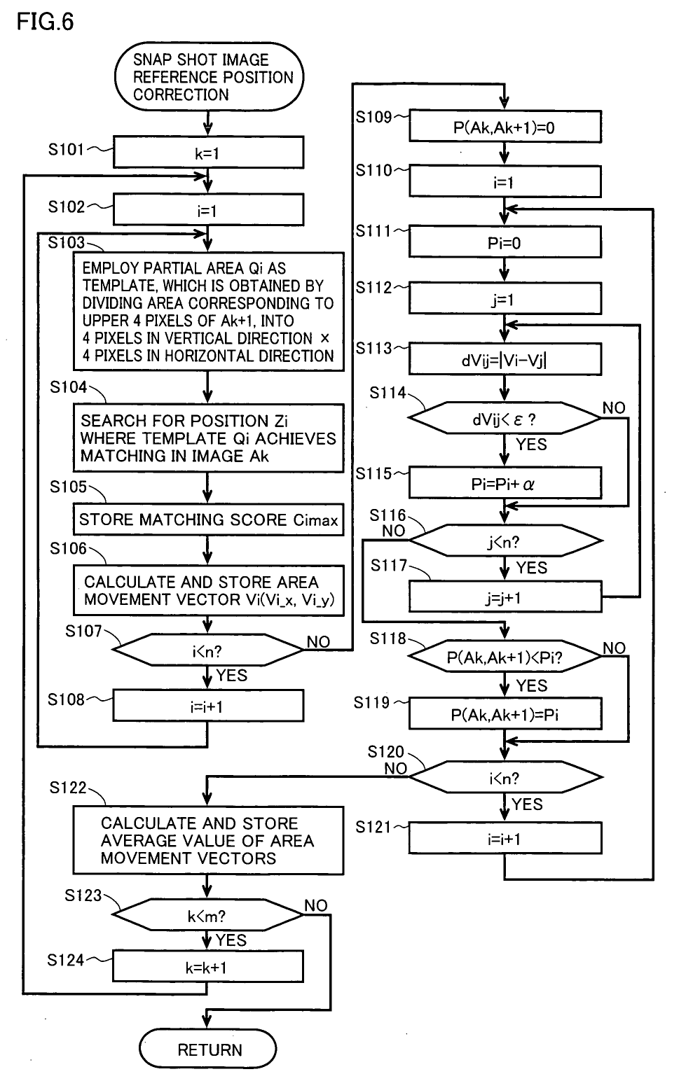

Thereafter, in authentication device 1, in step T11, a movement vector Vi−1, i of immediately preceding image Ai−1 and image Ai input in step T9 and corrected in step T10 is calculated (snap shot image reference position correction process). The contents of the process will be described with reference to FIG. 6 showing the flowchart of the subroutine of the process.

In the snap shot image reference position correction process, control unit 108 transmits a template matching start signal to calculating unit 1045 for relative positional relation between snap shot images, and waits until a template matching end signal is received. In calculating unit 1045 for relative positional relation between snap shot images, the template matching process such as shown from steps S101 to S108 in FIG. 6 starts.

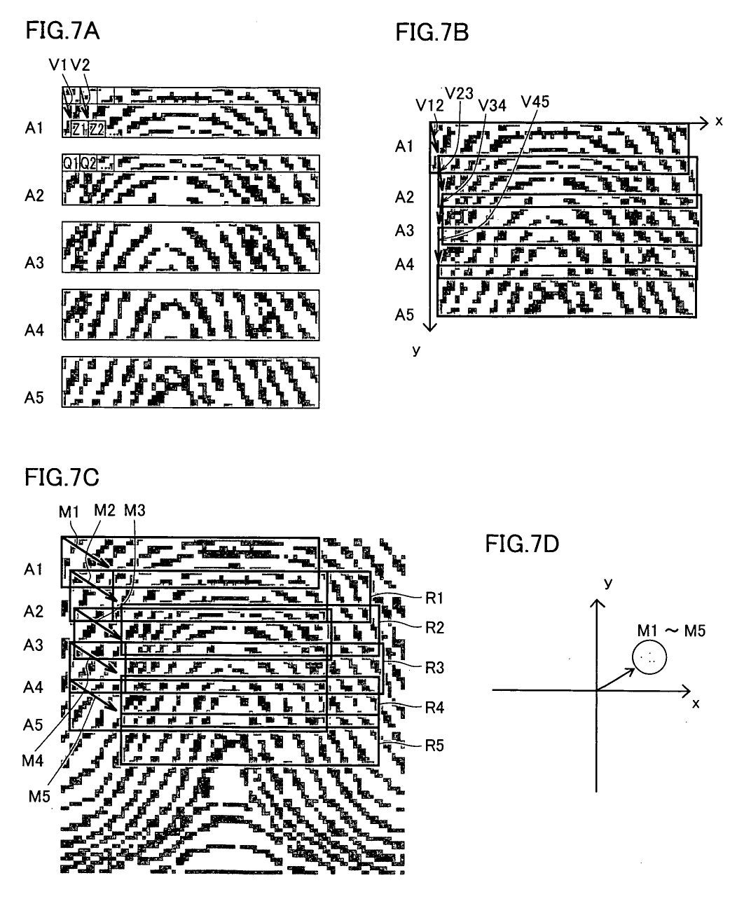

Broadly speaking, the template matching process refers to a process for searching for a position having the maximum matching score between snap shot images Ak and Ak+1, that is, a process for searching which partial area of image Ak attains the best match with each of a plurality of partial images of image Ak+1. Specifically, for example, referring further to FIGS. 7A to 7C, the position at which each of a plurality of partial images Q1, Q2, . . . of a snap shot image A2 attains the best match with one of partial images M1, M2, . . . of snap shot image A1 is searched for. Details will be described in the following. It is noted that images A1 to A5 in FIGS. 7A to 7C are images each showing a part of the fingerprint, sequentially from the top. These images were input sequentially, when the finger was moved upward over the sensor.

Referring to FIG. 6, in step S101, control unit 108 initializes a counter variable k to 1, and in step S102, control unit 108 initializes a counter variable i to 1.

Next, in step S103, control unit 108 defines an area corresponding to upper four pixel lines of image Ak+1 as a partial area Qi that is divided into 4 pixels in the vertical direction×4 pixels in the horizontal direction, and sets the image of this partial area as a template to be used for template matching. In the present embodiment, though partial area Qi has a rectangular shape for simplicity of calculation, the shape of partial area Qi is not limited thereto.

Thereafter, in step S104, control unit 108 searches for a portion of image Ak having the highest matching score with the template set in step S103, that is, a portion at which image Ak data best match the template. Specifically, for example, pixel density of coordinates (x, y), with an upper left corner of partial area Qi used as the template being the origin, is represented by Qi(x, y), pixel density of coordinates (s, t), with an upper left corner of image Ak being the origin, is represented by Ak(s, t), the width and height of partial area Qi are represented by w and h respectively, and possible maximum density of each pixel in images Qi and Ak is represented by V0. Here, matching score Ci(s, t) at coordinates (s, t) in image Ak is calculated, for example, in accordance with the following (Equation 01). It is noted that, according to the calculation, the matching score is calculated based on density difference between the pixels.

$$C i ( s , t ) = {\sum }_{y = 1}^{h} {\sum }_{x = 1}^{w} ( V 0 - \vert Q i ( x , y ) - Ak ( s + x , t + y ) \vert ) \qquad ( Equation 01 )$$

Thereafter, in step S105, control unit 108 successively updates coordinates (s, t) in image Ak, and calculates matching score C(s, t) at coordinates (s, t). A position having the highest value is considered as the maximum matching score position, the image of the partial area at that position is represented as a partial area Mi, and the matching score at that position is represented as a maximum matching score Cimax, which is stored at a prescribed address in memory 102.

Here, as described above, when image Ak is scanned to identify partial area Mi at a position M having the highest matching score with partial area Qi based on partial area Qi at a position P set in image Ak+1, a directional vector from position P to position M is referred to as a movement vector. This movement vector Vi is expressed in Equation (02).
Vi=(Vix, Viy)=(Mix−Rix, Miy−Riy) (Equation 02)

In (Equation 02), variables Qix and Qiy are x and y coordinates at the reference position of partial area Qi, that correspond, by way of example, to the upper left corner of partial area Qi in image Ak. Variables Mix and Miy are x and y coordinates at the position of maximum matching score Cimax as the result of search of partial area Mi, which correspond, by way of example, to the upper left corner coordinates of partial area Mi at the matched position in image Ak.

In step S106, control unit 108 calculates movement vector Vi described above and stores the same at a prescribed address in memory 102.

In step S107, control unit 108 determines whether counter variable i is not larger than the total number of partial areas n or not. If variable i is not larger than the total number n of the partial areas, the process proceeds to step S108, and otherwise, the process proceeds to step S109.

In step S108, control unit 108 adds 1 to the value of variable i. Thereafter, as long as variable value i is not larger than the total number n of partial areas, steps S102 to S107 are repeated. That is, template matching is performed for every partial area Qi. Thus, maximum matching score Cimax of each partial area Ri and movement vector Vi are calculated.

Maximum matching score position searching unit 105 stores maximum matching score Cimax and movement vector Vi for every partial area Qi calculated successively as described above at prescribed addresses of memory 102, and thereafter transmits a template matching end signal to control unit 108. Thereafter, control unit 108 transmits a similarity score calculation start signal to similarity score calculating unit 106, and waits until a similarity score calculation end signal is received.

Similarity score calculating unit 106 calculates the similarity score by performing the process shown with steps S109 to S124 in FIG. 5, using information such as movement vector Vi and maximum matching score Cimax of each partial area Qi obtained by template matching and stored in memory 102.

Here, broadly speaking, the similarity score calculation process refers to a process for calculating similarity between two images Ak and Ak+1, using the maximum matching score positions corresponding to respective ones of the plurality of partial areas obtained through the template matching process described above. Details will be described in the following. Generally, the data of snap shot images are data of one same person, and therefore, the similarity score calculation process may not be performed.

In step S109, control unit 108 initializes a similarity score P(Ak, Ak+1) to 0. Here, similarity score P(Ak, Ak+1) is a variable storing the degree of similarity between images Ak and Ak+1.

In step S110, control unit 108 initializes an index i of movement vector Vi as a reference to 1. Then, in step S1, control unit 108 initializes a similarity score Pi related to reference movement vector Vi to 0. Thereafter, in step S112, control unit 108 initializes an index j of a movement vector Vj as a reference to 1.

Then, in step S113, control unit 108 calculates a vector difference dVij between reference movement vector Vi and movement vector Vj in accordance with (Equation 03) below.
d Vij=|Vi−Vj|=\sqrt{(Vix−Vjx)²+(Viy−Vjy)²} (Equation 03)

Here, variables Vix and Viy represent x direction and y direction components respectively, of movement vector Vi, and variables Vjx and Vjy represent x direction and y direction components respectively, of movement vector Vj.

Thereafter, in step S114, control unit 108 compares vector difference dVij between movement vectors Vi and Vj with a prescribed constant ε, so as to determine whether movement vectors Vi and Vj can be regarded as substantially the same movement vectors. Specifically, if vector difference dVij is smaller than constant ε, movement vectors Vi and Vj are regarded as substantially the same, and the process proceeds to step S115. If the difference is larger than the constant, the movement vectors cannot be regarded as substantially the same, and the process proceeds to step S116.

In step S115, similarity score Pi is incremented in accordance with Equations (04) to (06) below.
Pi=Pi+α (Equation 04)
α=1 (Equation 05)
α=Cjmax (Equation 06)

In (Equation 04), variable a is a value for incrementing similarity score Pi. If α is set to 1 as represented by (Equation 05), similarity score Pi represents the number of partial areas that have the same movement vector as reference movement vector Vi. If α is set to α=Cjmax as represented by (Equation 06), similarity score Pi would be the total sum of the maximum matching scores obtained through template matching of partial areas that have the same movement vector as reference movement vector Vi. The value of variable α may be made smaller, in accordance with the magnitude of vector difference dVij.

In step S116, control unit 108 determines whether the value of index j is smaller than the total number n of partial areas or not. If the value of index j is smaller than the total number n of partial areas, the process proceeds to step S117, and if it is equal to or larger than n, the process proceeds to step S118.

In step S117, control unit 108 increments the value of index j by 1. By the process in steps S111 to S117, similarity score Pi is calculated, using the information of partial areas determined to have the same movement vector as reference movement vector Vi.

In step S118, control unit 108 compares similarity score Pi using movement vector Vi as a reference with variable P(Ak, Ak+1), and if similarity score Pi is larger than the largest similarity score (value of variable P(Ak, Ak+1)) obtained by that time, the process proceeds to step S119, and otherwise the process proceeds to step S120.

In step S119, control unit 108 sets a value of similarity score Pi using movement vector Vi as a reference to variable P(Ak, Ak+1), which is stored at a prescribed address in memory 102. According to the process in steps S118 and S119, if similarity score Pi using movement vector Vi as a reference is larger than the maximum value of the similarity score (value of variable P(Ak, Ak+1)) calculated by that time using other movement vector as a reference, reference movement vector Vi is considered to be the best reference among the values of index i used to that time point.

In step S120, the value of index i of reference movement vector Vi is compared with the number (value of variable n) of partial areas. If the value of index i is smaller than the number n of partial areas, index i is incremented by 1 in step S121, and thereafter the process returns to step S111.

Through steps S109 to S121, similarity between images Ak and Ak+1 is calculated as the value of variable P(Ak, Ak+1).

If it is determined in step S120 that index i is equal to or greater than the number n of partial areas, the process proceeds to step S122.

In step S122, similarity score calculating unit 106 stores the value of variable P(Ak, Ak+1) calculated in the above-described manner at a prescribed address of memory 102, and calculates average value Vk, k+1 of the area movement vectors in accordance with the following Equation (07).

$$Vk , k + 1 = ( {\sum }_{i = 1}^{n} V i ) / n \qquad Equation ( 07 )$$

Here, average value Vk, k+1 of the area movement vectors is calculated to obtain the relative positional relation between snap shot images Ak and Ak+1, based on the average value of the set of movement vectors Vi of respective partial areas Qi of each of the snap shot images. For example, with regard to snap shot images A1 and A2 in FIGS. 7A to 7C, the average vector of area movement vectors V1, V2, . . . is given as V12.

Referring again to FIG. 6, after the average value of the area movement vectors is calculated in step S122, control unit 108 compares the value of index k of snap shot image Ak as a reference image with the number of snap shot images (value of variable m) in step S123. If index k is smaller than the number of snap shot images, index k is incremented by 1 in step S124, and thereafter the process returns to step S101. If index k is not smaller than the number of snap shot images, control unit 108 transmits a calculation end signal to calculating unit 1043 for relative positional relation between snap shot images, so as to end the snap shot image reference position correction process. The process thus returns to step T11 in FIG. 4.

Referring again to FIG. 4, after the snap shot image reference position correction process is performed, control unit 108 adds movement vector Vi−1, i found in step T11 to vector Vsum obtained by accumulating the movement vectors on memory 102 as the vector, so as to calculate a new Vsum, which is stored at a prescribed address in memory 102 (step T12).

Thereafter, the fingerprint input and collation method is determined (step T13).

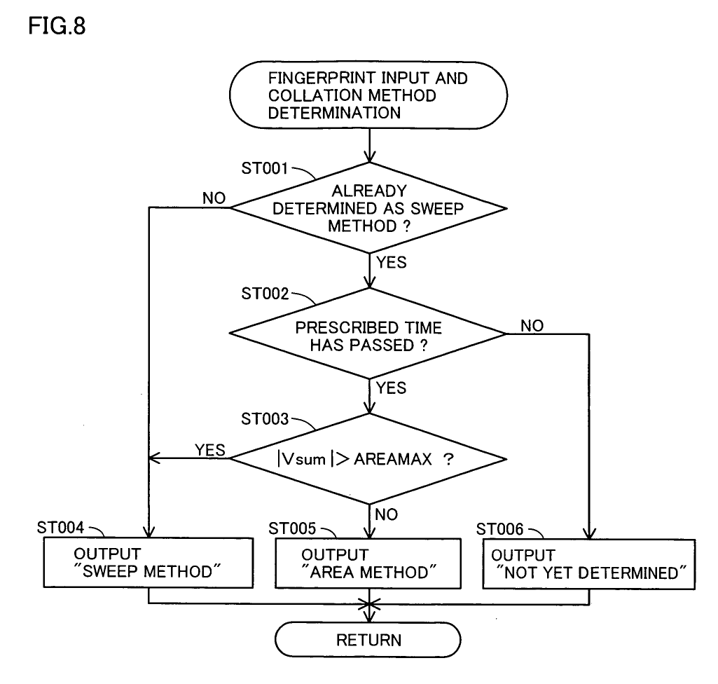

Here, the contents of the process for determining the fingerprint input and collation method in step T13 will be described. FIG. 8 shows the flowchart of the subroutine of the process.

Referring to FIG. 8, in the process for determining the fingerprint input and collation method, if it has already been determined as the sweep method at the time of execution of this process, the fingerprint input and collation method is set to the “sweep method” (steps ST001, ST004), and the process returns to step T13.

On the other hand, if it has not yet been determined as the sweep method and if variable i on memory 102 is smaller than a certain value (for example, READTIME), control unit 108 determines the fingerprint input and collation method as “not yet determined” (steps ST002, ST006), and the process returns to step T13.

In addition, if it has not yet been determined as the sweep method and if variable i above is equal to or greater than the certain value, control unit 108 refers to the value of vector variable Vsum on memory 102. If magnitude of the value (|Vₛᵤₘ|) is smaller than a certain value (for example, AREAMAX), control unit 108 sets the fingerprint input and collation method as the “area method”, and otherwise control unit 108 sets the method as the “sweep method” (steps ST003 to ST005). Then, the process returns to step T13.

Referring again to FIG. 4, after the fingerprint input and collation method is determined in step T13, control unit 108 determines how to proceed the process in accordance with the result of determination. Specifically, if it is determined as the sweep method, the process proceeds to step T15, and if it is determined as the area method, the process proceeds to step T16. If the method is not yet determined, the process proceeds to step T8.

In step T15, control unit 108 determines whether or not input of images (in image input unit 101) in accordance with the sweep method attains to predetermined count (NSWEEP). If control unit 108 determines that the predetermined count is attained, the process proceeds to step T16. If control unit 108 determines that the predetermined count is not yet attained, the process returns to step T8.

In step T16, control unit 108 transmits a registered data read start signal to a registered data reading unit 207, and waits until a registered data read end signal is received. Upon receiving the registered data read start signal, registered data reading unit 207 reads data of partial area Ri of an image registered in registered data storing unit 202 (hereinafter referred to as image B), and stores the same at a prescribed address of memory 102.

Then, after control unit 108 calculates the similarity score of image A and image B in step T17, control unit 108 performs collation and determination in step T18.

In the following, calculation of the similarity score in step T17 when the area method is selected and calculation of the same when the sweep method is selected will be described separately.

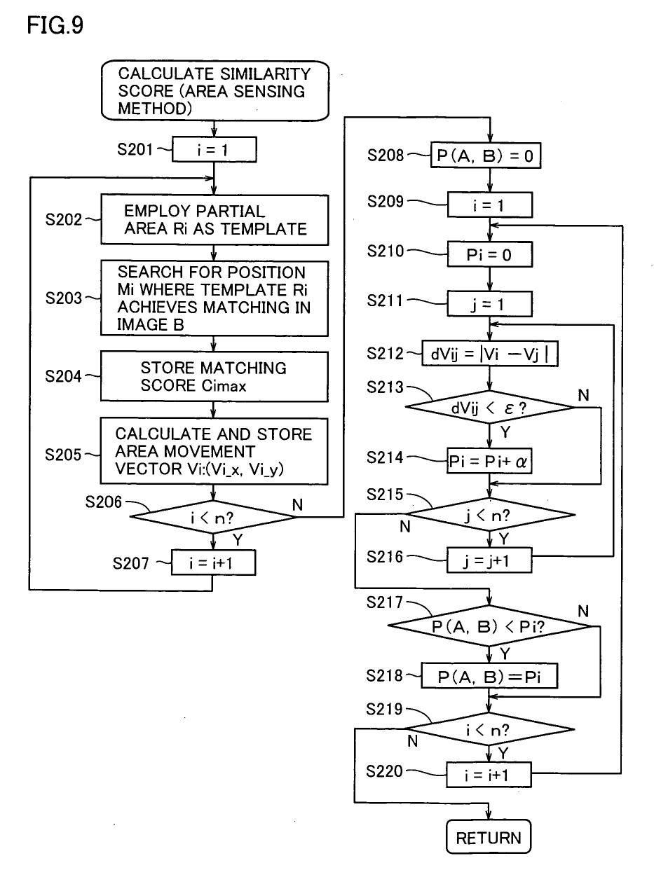

Initially, calculation of the similarity score when the area method is selected will be described with reference to FIG. 9.

Referring to FIG. 9, initially, control unit 108 transmits a template matching start signal to maximum matching score position searching unit 105, and waits until a template matching end signal is received. In response, maximum matching score position searching unit 105 starts a template matching process represented by steps S201 to S207.

Specifically, in the template matching process, initially in step S201, counter variable i is initialized to 1.

Next, in step S202, an image of a partial area defined as partial area Ri of image A is set as a template to be used for the template matching. Though partial area Ri has a rectangular shape for simplicity of calculation, the shape is not limited thereto.

Thereafter, in step S203, a portion of image B having the highest matching score with the template set in step S202, that is, a portion at which image data best match the template, is searched for. Specifically, for example, pixel density of coordinates (x, y), with an upper left corner of partial area Ri used as the template being the origin, is represented by Ri(x, y), pixel density of coordinates (s, t), with an upper left corner of image B being the origin, is represented by B(s, t), the width and height of partial area Ri are represented by w and h respectively, and possible maximum density of each pixel in images A and B is represented by V0. Here, matching score Ci(s, t) at coordinates (s, t) of image B is calculated, for example, in accordance with the following (Equation 08), based on density difference between the pixels.

$$C i ( s , t ) = {\sum }_{y = 1}^{h} {\sum }_{x = 1}^{w} ( V 0 - \vert R i ( x , y ) - B ( s + x , t + y ) \vert ) \qquad ( Equation 08 )$$

In image B, coordinates (s, t) are successively updated and matching score C(s, t) is calculated. A position having the highest value is considered as the maximum matching score position, the image of the partial area at that position is represented as partial area Mi, and the matching score at that position is represented as maximum matching score Cimax.

Then, in step S204, control unit 108 stores maximum matching score Cimax in image B for partial area Ri calculated in step S203 at a prescribed address of memory 102.

Thereafter, in step S205, control unit 108 calculates movement vector Vi in accordance with (Equation 09) below, which is stored at a prescribed address of memory 102.
Vi=(Vix, Viy)=(Mix−Rix, Miy−Riy) (Equation 09)

Here, if image B is scanned to identify partial area Mi at position M having the highest matching score with partial area Ri, based on partial area Ri at position P set in image A, a directional vector from position P to position M is referred to as a movement vector. This is because image B seems to have moved from one image, for example, image A as a reference, as the finger is placed in various manners on the fingerprint sensor.

In (Equation 08), variables Rix and Riy are x and y coordinates at the reference position of partial image Ri, that correspond, by way of example, to the upper left corner of partial image Ri in image A. Variables Mix and Miy are x and y coordinates at the position of maximum matching score Cimax as the result of search of partial area Mi, which correspond, by way of example, to the upper left corner coordinates of partial area Mi at the matched position in image B.

In step S206, control unit 108 determines whether counter variable i is not larger than the number of partial areas n. If variable i is not larger than the total number n of the partial areas, the process proceeds to step S207, and otherwise, the process proceeds to step S208.

In step S207, after control unit 108 adds 1 to the value of variable i, the process returns to step S202. Template matching is thus performed for every partial area Ri, and maximum matching score Cimax of each partial area Ri and the movement vector Vi are calculated.

Maximum matching score position searching unit 105 stores maximum matching score Cimax and movement vector Vi for every partial area Ri calculated successively as described above at prescribed addresses of memory 102, and thereafter transmits a template matching end signal to control unit 108.

Thereafter, control unit 108 transmits a similarity score calculation start signal to similarity score calculating unit 106, and waits until a similarity score calculation end signal is received. Similarity score calculating unit 106 calculates the similarity score through the process in steps S208 to S220, using information such as movement vector Vi and maximum matching score Cimax of each partial area Ri obtained by template matching and stored in memory 102.

Specifically, in step S208, similarity score P(A, B) is initialized to 0. Here, similarity score P(A, B) is a variable storing the degree of similarity between images A and B.

Thereafter, in step S209, index i of movement vector Vi as a reference is initialized to 1.

Then, in step S210, similarity score Pi related to reference movement vector Vi is initialized to 0.

Thereafter, in step S211, index j of movement vector Vj is initialized to 1.

Thereafter, in step S212, vector difference dVij between reference movement vector Vi and movement vector Vj is calculated in accordance with the following (Equation 10).
d Vij=|Vi−Vj|=\sqrt{(Vix−Vjx)²+(Viy−Vjy)²} (Equation 10)

Here, variables Vix and Viy represent x direction and y direction components respectively, of movement vector Vi, and variables Vjx and Vjy represent x direction and y direction components respectively, of movement vector Vj.

In step S213, vector difference dVij between movement vectors Vi and Vj is compared with prescribed constant ε, so as to determine whether movement vectors Vi and Vj can be regarded as substantially the same vectors. If vector difference dVij is determined as smaller than constant ε, movement vectors Vi and Vj are regarded as substantially the same, and the process proceeds to step S214. In contrast, if the difference is larger than the constant, the movement vectors cannot be regarded as substantially the same, and the process proceeds to step S215.

In step S214, similarity score Pi is incremented in accordance with Equations (11) to (13) below.
Pi=Pi+α (Equation 11)
α=1 (Equation 12)
α=Cjmax (Equation 13)

In (Equation 11), variable α is a value for incrementing similarity score Pi. If α is set to 1 as represented by (Equation 12), similarity score Pi represents the number of partial areas that have the same movement vector as reference movement vector Vi. If α is set to α=Cjmax as represented by (Equation 13), similarity score Pi would be the total sum of the maximum matching scores obtained through template matching of partial areas that have the same movement vector as reference movement vector Vi. The value of variable α may be made smaller, in accordance with the magnitude of vector difference dVij.

In step S215, whether the value of index j is smaller than the total number n of partial areas or not is determined. If the value of index j is smaller than the total number n of partial areas, the process proceeds to step S216, and if it is larger, the process proceeds to step S217.

In step S216, the value of index j is incremented by 1.

By the process from steps S210 to S216 described above, similarity score Pi is calculated, using the information of partial areas determined to have the same movement vector as reference movement vector Vi.

In step S217, similarity score Pi using movement vector Vi as a reference is compared with variable P(A, B), and if similarity score Pi is larger than the largest similarity score (value of variable P(A, B)) obtained by that time, the process proceeds to step S218, and if it is smaller, the process proceeds to step S219.

In step S218, a value of similarity score Pi using movement vector Vi as a reference is set to variable P(A, B). In steps S217 and S218, if similarity score Pi using movement vector Vi as a reference is larger than the maximum value of the similarity score (value of variable P(A, B)) calculated by that time using other movement vector as a reference, reference movement vector Vi is considered to be the best reference among the values of index i used to that time point.

In step S219, the value of index i of reference movement vector Vi is compared with the number (value of variable n) of partial areas. If the value of index i is smaller than the number of partial areas, the process proceeds to step S220.

In step S220, after index value i is incremented by 1, the process returns to step S210.

By the steps S208 to S220 described above, similarity between images A and B is calculated as the value of variable P(A, B). Similarity score calculating unit 106 stores the value of variable P(A, B) calculated in the above-described manner at a prescribed address of memory 102, and transmits a similarity score calculation end signal to control unit 108, and the process returns to step T17.

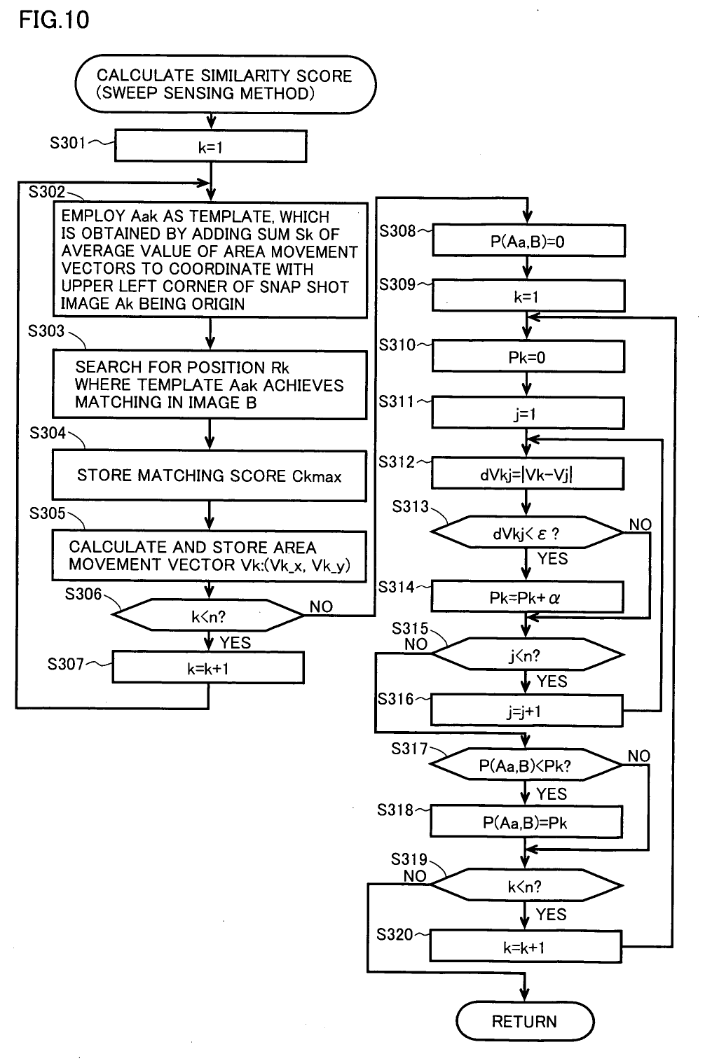

Calculation of the similarity score when the sweep method is selected will now be described with reference to FIG. 10.

Referring to FIG. 10, control unit 108 transmits a template matching start signal to maximum matching score position searching unit 105, and waits until a template matching end signal is received. Maximum matching score position searching unit 105 starts a template matching process represented by steps S301 to S307.

The template matching process here is a process for searching for the maximum matching score position, which is the position of the partial area image where each of the set of snap shot images reflecting the reference position calculated by calculating unit 1045 for relative positional relation between snap shot images described above attains the maximum matching score on an image different from the set of snap shot images. Details will be described below.

First, in step S301, counter variable k is initialized to 1.

Next, in step S302, a template to be used for the template matching is set. Here, the template is an image of a partial area defined as Aak obtained by adding the total sum Pk of average value Vk, k+1 of area movement vectors to the coordinates of the upper left corner of snap shot image Ak as a reference. Here, Pk is defined by the following Equation (14).

$$Pk = {\sum }_{i = 1}^{i - 1} V i - 1 , i \qquad ( Equation 14 )$$

Thereafter, in step S303, a portion of image B having the highest matching score with the template set in step S302, that is, a portion at which image data best match the template, is searched for. Specifically, pixel density of coordinates (x, y), with an upper left corner of partial area Aak used as the template being the origin, is represented by Aak(x, y), pixel density of coordinates (s, t), with an upper left corner of image B being the origin, is represented by B(s, t), the width and height of partial area Aak are represented by w and h respectively, and possible maximum density of each pixel in image Aak and image B is represented by V0. Here, matching score Ci(s, t) at coordinates (s, t) of image B is calculated, for example, in accordance with the following Equation (15), based on density difference between the pixels.

$$C i ( s , t ) = {\sum }_{y = 1}^{h} {\sum }_{x = 1}^{w} ( V 0 - \vert Aak ( x , y ) - B ( s + x , t + y ) \vert ) \qquad ( Equation 15 )$$

In image B, coordinates (s, t) are successively updated and matching score C(s, t) at coordinate (s, t) is calculated. A position having the highest value is considered as the maximum matching score position, the image of the partial area at that position is represented as partial area Rk, and the matching score at that position is represented as maximum matching score Ckmax.

Then, in step S304, maximum matching score Ckmax in image B for partial area Aak calculated in step S303 is stored in a prescribed address of memory 102.

Thereafter, in step S305, movement vector Vk is calculated in accordance with Equation (16) below, which is stored at a prescribed address of memory 102.
Vk=(Vkx, Vky)=(Rkx−Aakx, Rky−Aaky) Equation (16)

Here, if image B is scanned to identify partial area Rk at position R having the highest matching score with partial area Aak based on partial area Aak as described above, a directional vector from a position Aa to position R is referred to as a movement vector. This is because image B seems to have moved from one image, for example, image A as a reference, as the finger is placed in various manners on the fingerprint sensor.

In Equation (16), variables Aakx and Aaky are x and y coordinates at the reference position of partial area Aak obtained by adding the total sum Pn of average values Vk, k+1 of area movement vectors to the coordinates with the upper left corner of snap shot image Ak being the origin.

Variables Rkx and Rky are x and y coordinates at the position of maximum matching score Ckmax as the result of search of partial area Rk. For example, coordinates (Rkx, Rky) correspond to the upper left corner coordinates of partial area Rk at the matched position in image B.

Thereafter, in step S306, whether counter variable k is not larger than the total number of partial areas n is determined. If variable k is not larger than the total number n of the partial areas (YES in S306), the process proceeds to S307 and otherwise (NO in S306), the process proceeds to S308. Namely, in step S307, variable value k is incremented by 1.

Thereafter, as long as variable value k is not larger than the total number n of partial areas, the process in steps S302 to S307 is repeated, and template matching is performed for every partial area Aak. Thus, maximum matching score Ckmax of each partial area Aak and movement vector Vk are calculated.

Maximum matching score position searching unit 105 stores maximum matching score Ckmax and movement vector Vk for every partial area Aak calculated successively as described above at prescribed addresses of memory 102, and thereafter transmits a template matching end signal to control unit 108.

In response, control unit 108 transmits a similarity score calculation start signal to similarity score calculating unit 106, and waits until a similarity score calculation end signal is received.

Similarity score calculating unit 106 calculates the similarity score by performing the process in steps S308 to S320, using information such as movement vector Vk and maximum matching score Ckmax of each partial area Aak obtained by template matching and stored in memory 102.

In the similarity score calculation process here, initially, a position of the partial area image where each of one set of snap shot images reflecting the reference position calculated by calculating unit 1045 for relative positional relation between snap shot images in the template matching process described above attains the maximum matching score on an image different from the set of snap shot images is searched for, thus obtaining the maximum matching score position for each image. Then, the similarity score is determined based on whether each positional relation value indicating the positional relation of each of the aforementioned set of snap shot images and the maximum matching score position that has been searched for is within a prescribed threshold value or not. Details of this process will be described in the following.

In step S308, similarity score P(Aa, B) is initialized to 0. Here, similarity score P(Aa, B) is a variable storing the degree of similarity between images Aa and B.

Then, in step S309, index k of movement vector Vk as a reference is initialized to 1.

Thereafter, in step S310, similarity score Pk related to reference movement vector Vk is initialized to 0.

Then, in step S311, index j of movement vector Vj is initialized to 1.

Thereafter, in step S312, vector difference dVkj between reference movement vector Vk and movement vector Vj is calculated in accordance with the following Equation (17).
d Vkj=|Vk−Vj|=\sqrt{(Vkx−Vjx)²+(Vky−Vjy)²} (Equation 17)

Here, variables Vkx and Vky represent x direction and y direction components respectively, of movement vector Vk, and variables Vjx and Vjy represent x direction and y direction components respectively, of movement vector Vj.

Then, in step S313, vector difference dVkj between movement vectors Vk and Vj is compared with prescribed constant ε, so as to determine whether movement vectors Vk and Vj can be regarded as substantially the same vectors. If vector difference dVkj is smaller than constant ε (YES in S313), movement vectors Vk and Vj are regarded as substantially the same, and the process proceeds to step S314. If the difference is larger than constant ε (NO in S313), movement vectors Vk and Vj cannot be regarded as substantially the same, and the process proceeds to step S315 (skipping step S314).

In step S314, similarity score Pk is incremented in accordance with Equations (18) to (20) below.
Pk=Pk+α Equation (18)
α=1 Equation (19)
α=Ckmax Equation (20)

In Equation (18), variable α is a value for incrementing similarity score Pk. If α is set to 1 as represented by Equation (19), similarity score Pk represents the number of partial areas that have the same movement vector as reference movement vector Vk. If α is set to α=Ckmax as represented by Equation (20), similarity score Pk would be the total sum of the maximum matching scores obtained through template matching of partial areas that have the same movement vector as reference movement vector Vk. The value of variable a may be made smaller, in accordance with the magnitude of vector difference dVkj.

In step S315, whether the value of index j is smaller than the total number n of partial areas or not is determined. If the value of index j is determined to be smaller than the total number n of partial areas (YES in S315), the process proceeds to step S316, and if it is determined to be larger (NO in S315), the process proceeds to step S317. In step S316, the value of index j is incremented by 1, and the process proceeds to step S317.

By the process from steps S310 to S316 described above, similarity score Pk is calculated, using the information of partial areas determined to have the same movement vector as reference movement vector Vk.

In step S317, similarity score Pk using movement vector Vk as a reference is compared with variable P(Aa, B), and if similarity score Pk is larger than the largest similarity score (value of variable P(Aa, B)) obtained by that time (YES in S317), the process proceeds to step S318, and otherwise (NO in S317) the process proceeds to step S319 (skipping step S318). In step S318, a value of similarity score Pk using movement vector Vk as a reference is set to variable P(Aa, B), and the process proceeds to step S319.

In other words, in steps S317 and S318, if similarity score Pk using movement vector Vk as a reference is larger than the maximum value of the similarity score (value of variable P(Aa, B)) calculated by that time using other movement vector as a reference, reference movement vector Vk is considered to be the best reference among the values of index k used to that time point.

Next, in step S319, the value of index k of reference movement vector Vk is compared with the number (value of variable n) of partial areas. If the value of index k is smaller than the number n of partial areas (YES in S319), the process proceeds to step S320. In step S320, index value k is incremented by 1, and the process returns to step S310.

As steps S308 to S320 described above are repeated until index k attains to the number n of partial areas (NO in S319), similarity between images Aa and B is calculated as the value of variable P(Aa, B). Similarity score calculating unit 106 stores the value of variable P(Aa, B) calculated in the above-described manner as the similarity score at a prescribed address of memory 102, and transmits a similarity score calculation end signal to control unit 108. The similarity score is thus stored, and the similarity score calculation process ends. Then, the process returns to T17.

Referring again to FIG. 4, after calculating the similarity score in step T17, control unit 108 transmits a collation determination start signal to collation determining unit 107, and waits until a collation determination end signal is received.

In response, collation determining unit 107 collates the image input to image input unit 101 with the image stored in registered data storing unit 202, and determines whether or not the images match with each other (step T18).

Specifically, the similarity score represented by the value of variable P(Aa, B) stored in memory 102 is compared with a predetermined threshold T for collation. If variable P(Aa, B)≧T, it is determined that images Aa and B are taken from one same fingerprint, and a value (for example, 1) indicating a match is written to a prescribed address of memory 102 as a collation result. On the other hand, if P(Aa, B)<T, the images input to image input unit 101 are determined to have been taken from different fingerprints and a value (for example, 0) indicating a mismatch is written to a prescribed address of memory 102 as a collation result. Thereafter, a collation determination end signal is transmitted to control unit 108, and the process in step T18 ends.

It is noted that the radius of the circle in FIG. 7D corresponds to constant ε above. In step T18, with regard to those of the movement vectors that are within this circle, α is added to variable P(Aa, B). In determination in step T18, variable P(Aa, B) is compared with T, to determine whether the images match. In other words, if α is “1”, the images are determined to be matching, if there are T or more movement vectors found in the circle.

Then, in step T19, authentication unit 1077 performs authentication of an individual or the like corresponding to combination of the collated images.

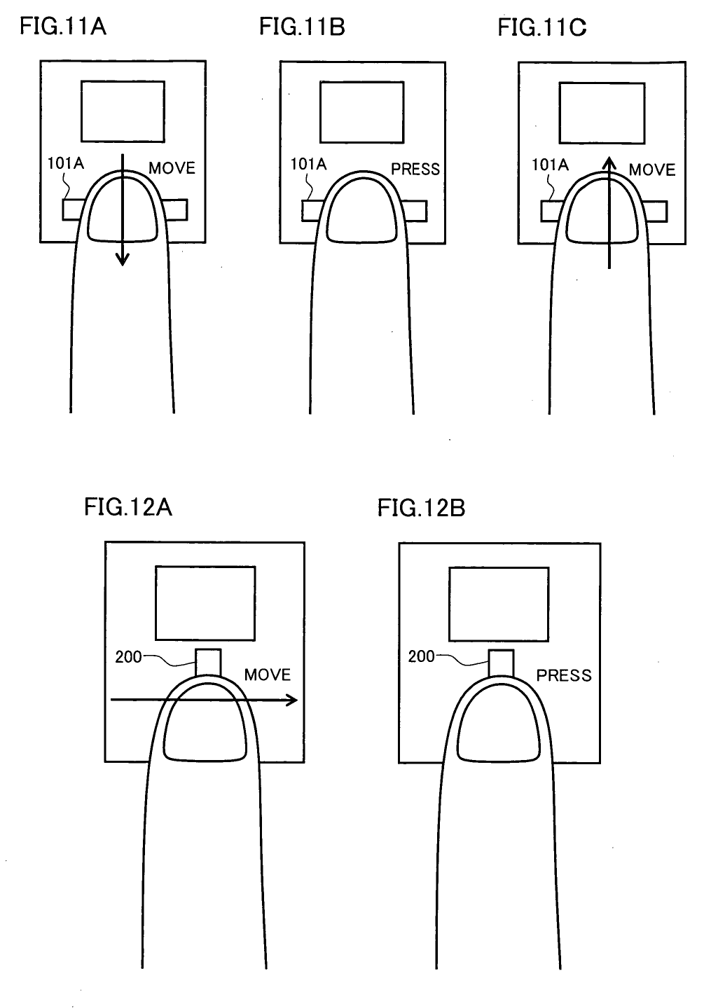

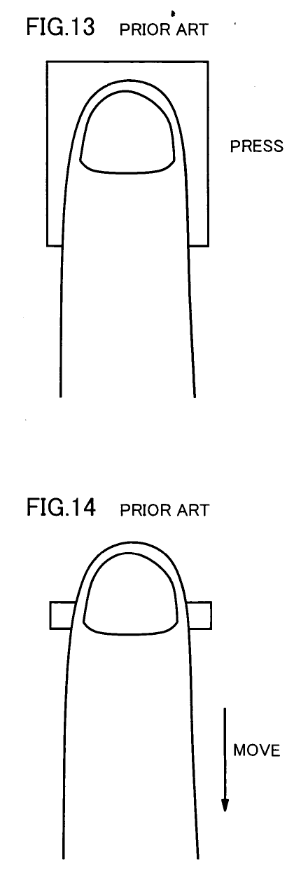

In the present embodiment, authentication is carried out using collation in accordance with the area method and collation in accordance with the sweep method in combination. Here, collation in accordance with the area method refers to a manner of collation using fingerprint data obtained by sensing in accordance with the area method using the sensor of image input unit 101. Meanwhile, collation in accordance with the sweep method refers to a manner of collation using fingerprint data obtained by sensing in accordance with the sweep method using the sensor of image input unit 101. In the following, the contents of authentication in the present embodiment will be described with reference to FIG. 11.

In authentication in the present embodiment, initially, as shown in FIG. 11A, collation in accordance with the sweep method using the image input by moving the forefinger of the right hand in a downward direction is carried out. Thereafter, as shown in FIG. 11B, collation in accordance with the area method with regard to the image of the forefinger of the right hand is carried out. Then, as shown in FIG. 11C, collation in accordance with the sweep method using the image input by moving the forefinger of the right hand in an upward direction is carried out.

Specifically, initially, in steps T1 to T18 shown in FIG. 4, collation of the image input in accordance with the sweep method and collation data of the forefinger of the right hand obtained by moving the finger in the downward direction and registered in advance is carried out. The result of collation is stored in the register included in authentication unit 1077.

Thereafter, collation of the image input in accordance with the area method and collation data of the forefinger of the right hand registered in advance is carried out. The result of collation is stored in the register included in authentication unit 1077.

Then, collation of the image input in accordance with the sweep method and collation data of the forefinger of the right hand obtained by moving the finger in the upward direction and registered in advance is carried out. The result of collation is compared with the result of collation previously stored in the register included in authentication unit 1077.

If all collation results (the results of collation using the sweep method in the downward direction, the area method, and the sweep method in the upward direction) match, it is determined that collation succeeded, and the result of authentication based on the collation result is output. Specifically, if the collation result indicates “match”, the user who input the fingerprint is approved. On the other hand, if the collation result indicates “mismatch”, the user who input the fingerprint is not approved.

Meanwhile, if all collation results do not match, that is, if at least one of the result of collation using the sweep method in the downward direction, the result of collation using the area method, and the result of collation using the sweep method in the upward direction is different in the example above, it is determined that collation did not succeed, and the authentication process ends with the user being left unapproved. Specifically, a process, for example, for displaying a message that the authentication process has failed and a message requesting the user to try again the input of the fingerprint to image input unit 101 is performed.

In the present embodiment, as described above, an example in which the result of collation using each method is stored in the register within authentication unit 1077, however, the present invention is not limited to such a configuration. For example, the collation result may be stored in memory 102.

In addition, in the present embodiment, as described with reference to FIGS. 11A to 11C, collation using the sweep method based on movement of a finger in the downward direction, collation using the area method, and the collation using the sweep method based on movement of a finger in the upward direction are successively performed for fingerprint identification, however, collation in the present invention is not limited to collation in such an order and combination, so long as collation using the area method and collation using the sweep method are included.

Alternatively, combination of collation methods may be modified in order to vary security level, for each application for authentication.

As described above, the fingerprint identification is carried out by using collation in accordance with the area method and collation in accordance with the sweep method in combination as in the present embodiment, so that erroneous authentication or spoofing can be less likely than in the conventional example in which authentication has been carried out using solely collation in accordance with the area sensing method or collation in accordance with the sweep sensing method.

(Second Embodiment)

In the first embodiment described above, the process function for collating images is achieved by a program. In the present embodiment, the program is stored in a computer-readable recording medium. In the present embodiment, the recording medium may be a memory itself (that is, a program medium) necessary for the processing by the computer shown in FIG. 1, such as memory 624, or alternatively, it may be a recording medium detachably mounted on the computer and readable through an external memory device in the computer. Examples of such an external memory device are a magnetic tape device (not shown), FD drive 630 and CD-ROM drive 640, and examples of such a recording medium are a magnetic tape (not shown), FD 632 and CD-ROM 642. In any case, the program recorded on each recording medium may be accessed and executed by CPU 622, or the program may be once read from the recording medium and loaded to a prescribed program storage area (such as memory 624) in the computer, and then read and executed by CPU 624. It is assumed that the program for loading is stored in advance in the computer.

Here, the recording medium mentioned above is configured to be detachable from the computer body. A medium fixedly carrying the program may be applicable as the recording medium. Specific examples may include tapes such as magnetic tapes and cassette tapes, discs including magnetic discs such as FD 632 and fixed disk 626 and optical discs such as CD-ROM 642/MO (Magnetic Optical Disc)/MD (Mini Disc)/DVD (Digital Versatile Disc), cards such as an IC card (including memory card)/optical card, and semiconductor memories such as a mask ROM, EPROM (Erasable and Programmable ROM), EEPROM (Electrically EPROM) and a flash ROM.

In the computer shown in FIG. 1, a configuration that allows connection to communication network 300 including the Internet for establishing communication has been adopted. Therefore, the program may be downloaded from communication network 300 and held on a recording medium in a non-fixed manner. When the program is downloaded from communication network 300, the program for downloading may be stored in advance in the computer body, or it may be installed in advance in the computer body from a different recording medium.

The contents stored in the recording medium are not limited to a program, and may include data.

In the embodiment described above, though horizontally long rectangular sensor 101A as shown in FIG. 3A or the like has been employed as the fingerprint sensor, the sensor used in the present invention is not limited as such.

For example, as shown in FIGS. 12A and 12B, the sensor may be implemented by a vertically long sensor 200. In using sensor 200, when fingerprint data is sensed in accordance with the sweep method using the fingerprint sensor included in image input unit 101, the user places his/her finger along the longitudinal direction of rectangular sensor 200 as shown in FIG. 12A, and moves the finger over sensor 200 in a direction orthogonal to the longitudinal direction of sensor 200 from left to right (or from right to left) as shown with an arrow in the drawing, so that the fingerprint data is read. In sensing the fingerprint data in accordance with the area method, the user places his/her finger on rectangular sensor 200 as shown in FIG. 12B, so that the fingerprint data is read while the finger is kept stationary on sensor 200.

The embodiment described above discloses the technique to input the image in accordance with the sweep method, in which the images based on movement of the finger in the downward and upward directions are used in collation. That is, the present specification discloses the technique to input, as the image used for collation, a plurality of images in accordance with one method (the area method or the sweep method) but in different manner of input. By adopting such a technique, accuracy in collation and authentication can further be improved.

In the present embodiment described above, the authentication device is allowed to output the authentication result only when all results of collation based on the images input in different methods match. The authentication accuracy can thus further be improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An authentication device comprising:
an image input unit including a sensor and allowing input of an image of an object using either a first method in which relative position between said sensor and said object is fixed or a second method in which relative position between said sensor and said object is varied;
a reference image holding unit holding a reference image to be collated with an input image input through said image input unit;
a first collating unit collating a first input image input through said image input unit using said first method with said reference image;
a second collating unit collating a second input image input through said image input unit using said second method with said reference image; and
an authentication unit outputting a result of authentication based on a result of collation by said first collating unit and a result of collation by said second collating unit.

2. The authentication device according to claim 1, wherein
at least one of said first collating unit and said second collating unit collates respective input images input by using different methods with said reference image.

3. The authentication device according to claim 1, wherein
said authentication unit outputs the result of authentication based on the result of collation only when the result of collation by said first collating unit is identical to the result of collation by said second collating unit.

4. An authentication method, comprising the steps of:
collating a first input image with a reference image, the first input image being input with relative position between a sensor and an object being fixed;
collating a second input image with the reference image, the second input image being input with relative position between a sensor and an object being varied; and
outputting a result of authentication based on a result of collation of said first input image and a result of collation of said second input image.

5. An authentication program for authentication based on an image input to a sensor, causing a computer to execute the steps of:
collating a first input image with a reference image, the first input image being input with relative position between said sensor and an object being fixed;
collating a second input image with the reference image, the second input image being input with relative position between said sensor and an object being varied; and
outputting a result of authentication based on a result of collation of said first input image and a result of collation of said second input image.

6. A computer-readable recording medium recording the authentication program according to claim 5.
